(19) United States
(12) Patent Application Publication
(10) Pub. No.: US 2005/0083976 A1
(43) Pub. Date: Apr. 21, 2005

(54) Embedding tv anytime crids

(75) Inventors: Alexis Stephen Richard Ashley, Redhill (GB); Andrew James Hickman, London (GB); Octavius John Morris, Redhill (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/502,151

(22) PCT Filed: Jan. 14, 2003
(86) PCT No.: PCT/IB03/00077

(30) Foreign Application Priority Data
Jan. 24, 2002 (GB) 0201594.9
Mar. 18, 2002 (GB) 0206257.8
Aug. 20, 2002 (GB) 0219470.2

(51) Int. Cl. H04J 3/02

(52) U.S. Cl. 370/537

(57) ABSTRACT

A method of creating an audio/video stream comprises multiplexing a video component, an audio component and a content reference identifier, the content reference identifier is associated with the video component and the audio component in an MPEG transport stream. Apparatus for transmitting and receiving the audio/video stream isalso described.

This invention relates to a method for embedding TV Anytime CRIDs in an audio/video stream.

The TV Anytime Forum (http://tv-anytime.org) have defined CRID (Content Reference Identifier), which provides a unique identifier for a piece of A/V (AudioVideo) content, independent of how that content is actually obtained. By using the CRID, TV Anytime systems (such as Personal Video Recorders) are able to offer enhanced recording features (e.g. one-touch recording, recording groups of programmes, smart recording of repeats to avoid recording conflicts, etc.)

The DVB (Digital Video Broadcasting) standard (one example of broadcast standard) defines a present/following Event Information Table (EIT), which gives the start time, duration and other data of the current and next programme (similar mechanisms are defined by the ATSC and ARIB broadcasting standards). Each event has an eventId, which allows a receiver to determine unambiguously when a particular event (i.e. programme) starts and finishes. The EIT technology has several drawbacks including that there is at most one event present at each instant in time (see page 13 of ETR 211). However, it is useful to attach several TV Anytime CRIDs to the same programme. Equally EIT eventIDs have limited functionality and certainly do not offer the powerful referencing capabilities of TV Anytime CRIDs. Furthermore they do not allow references to be made to programmes related in some way to the current event.

It is an object of the invention to improve upon the known systems.

To enable a number of user features it is desirable to be able to insert simultaneously a number of TV Anytime CRIDs into an A/V stream. The mechanism should advantageously include the following features. The CRID should be insertable on an event basis, i.e. its insertion should persist for the same duration of time as the A/V content to which it is attached. The insertion should be relatively time-accurate: the start and end of insertion should correspond to within about 2 seconds of the start and end of the associated event. For some types of CRID it may be appropriate to make this time greater. There should be a method for embedding the data of the CRID itself, along with any associated data that might be used in interpreting that CRID. It should be possible to insert multiple CRIDs simultaneously, each of which can have different start and end insertion times. The data should be easily retrievable from the A/V stream, without requiring a complete video decode (since this CRID information might need to be accessed when a programme is not being decoded).

The CRID can be used to identify content in many different ways, but one useful application is to include CRIDs in an A/V stream in order to identify the content contained within that stream, as well as other content related in some way to the content in that stream. Embedding CRIDs in the A/V stream makes it possible to offer easy-to-use recording functionality, including offering the opportunity to record: a programme that is being trailered, the next programme in a series, or a whole series when an individual episode is being watched.

According to a first aspect of the present invention, there is provided a method of creating an audio/video stream comprising multiplexing a video component, an audio component and a content reference identifier, said content reference identifier being associated with said video component and said audio component in an MPEG transport stream.

According to a second aspect of the present invention, there is provided apparatus for transmitting an audio/video stream comprising a multiplexer for multiplexing a video component, an audio component and a content reference identifier, said content reference identifier being associated with said video component and said audio component in an MPEG transport stream, and transmitting means for transmitting the resulting audio/video stream.

According to a third aspect of the present invention, there is provided apparatus for receiving an audio/video stream comprising receiving means for receiving an audio/video stream comprising a video component, an audio component and a content reference identifier, said content reference identifier being associated with said video component and said audio component in an MPEG transport stream and a demultiplexer for demultiplexing said audio/video stream.

According to a fourth aspect of the present invention, there is provided an audio/video stream comprising a video component, an audio component and a content reference identifier, said content reference identifier being associated with said video component and said audio component in an MPEG transport stream.

Owing to the invention it is possible to provide an enhanced handling of an audio/video stream.

Embodiments of the invention will now be described, by way of example only, with reference to the accompanying drawings, in which:

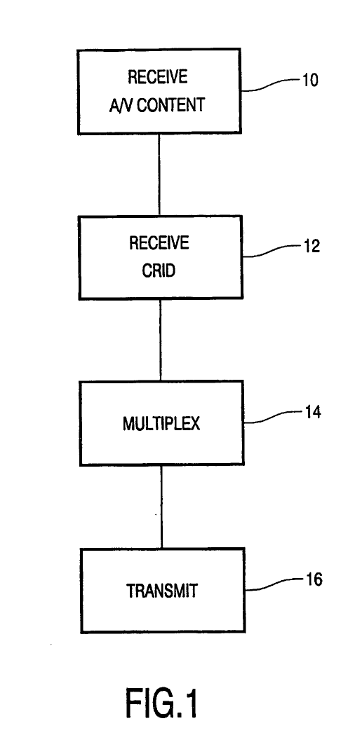

FIG. 1 is a flowchart of a method of creating an audio/video stream,

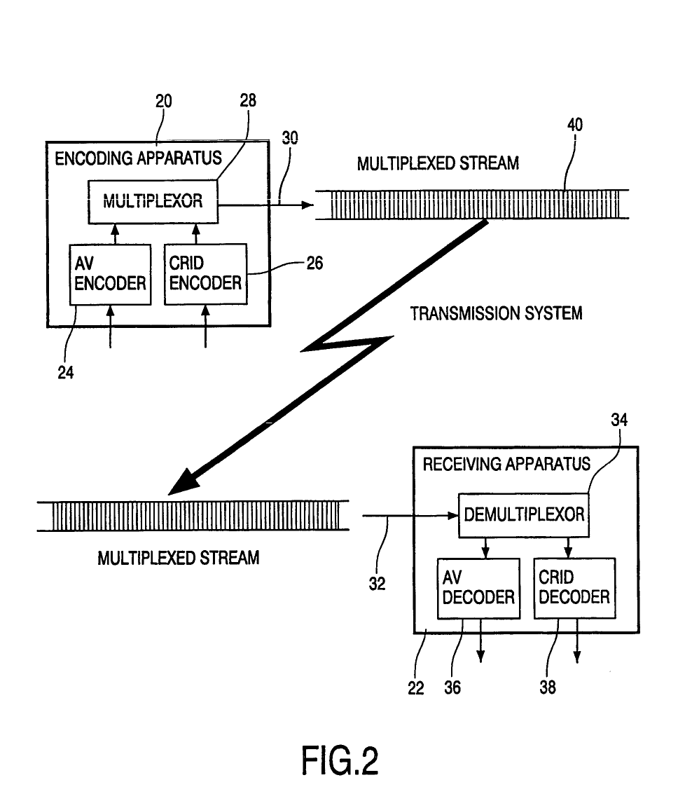

FIG. 2 is a schematic diagram of an end-to-end system,

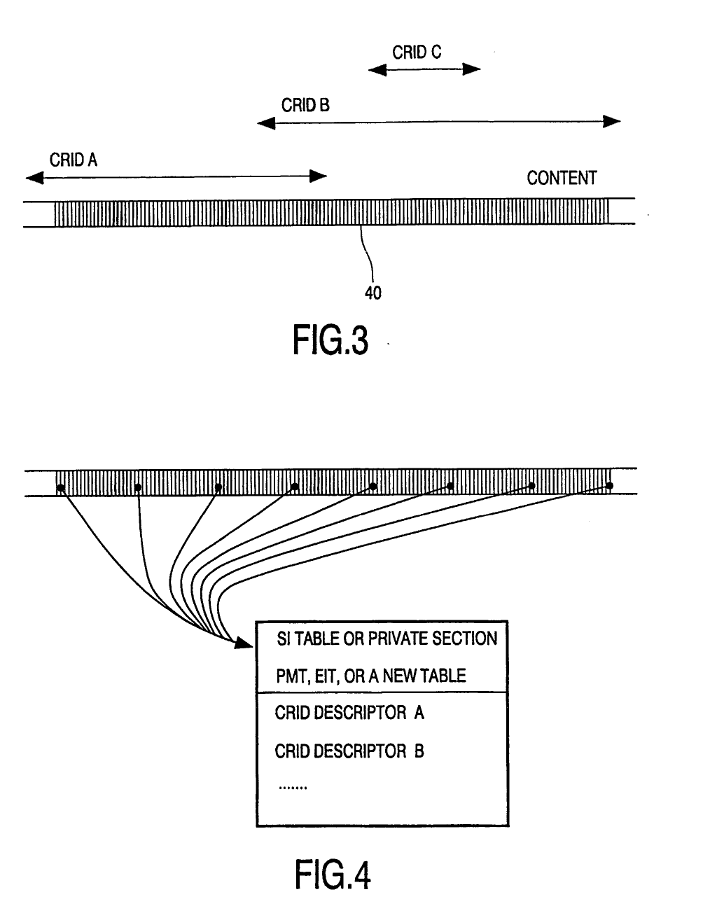

FIG. 3 is a schematic diagram of an audio/video stream showing how content reference identifiers (CRIDs) need to overlap when embedded in the audio/visual content,

FIG. 4 is a schematic diagram of an audio/video stream showing how CRID descriptors can be inserted repetitively into a broadcast, and

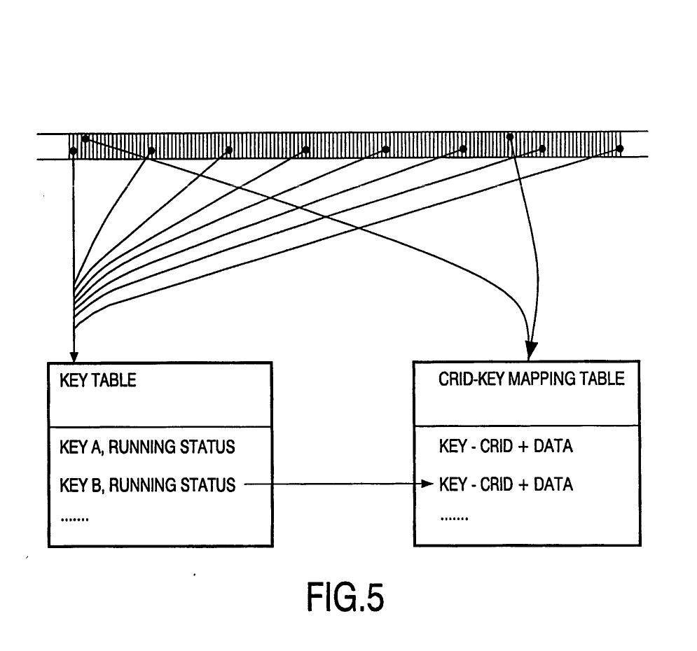

FIG. 5 is a schematic diagram of an audio/video stream showing a two-level table structure for transmitting CRID information.

The flowchart of FIG. 1 shows the method of creating an audio/visual stream by embedding at least one content reference identifier in the stream. An end-to-end system is shown in FIG. 2, illustrating the encoding and transmitting apparatus 20 and the corresponding receiving apparatus 22. The encoding apparatus 20 creates the audio/visual stream. The encoding apparatus 20 carries out the method of FIG. 1.

The first step in the method is the step 10 of receiving the audio/video content. This will typically be received from a local storage medium and is received by the audio/video encoder 24 for supplying of the video and audio components to a multiplexer 28. The second step in the method is the step 12 of receiving at least one associated content reference identifier, which again will be received from a local store. The CRID(s) is/are then received by a CRID encoder 26, for subsequent embedding in the resulting audio/video stream.

The third step in the method is the step 14, which comprises multiplexing the video and audio components and the content reference identifier together to create an audio/video stream in the form of an MPEG transport stream. The content reference identifier is associated with the video and audio components. This multiplexing is carried out by the multiplexer 28. If multiple CRIDs are supplied by the CRID encoder 26, then the multiplexing includes simultaneously multiplexing the plurality of CRIDs into the audio/video stream.

The final step in the method is the step 16 of transmitting the resulting audio/video stream. This is carried out by transmitting means 30, which broadcasts the audio/video stream 40 that comprises the video component, the audio component and at least one content reference identifier in the form of an MPEG transport stream. A number of different transmission systems are possible, including standard wireless, cable and telephone (copper wire) systems.

A simple example of the system in application would be a terrestrial broadcast network, where the video and audio components relate to a film that is to be broadcast. Two CRIDs are multiplexed into the audio/video stream, one relating to the film itself, and the other relating to the sequel of the film, which is to be broadcast by the network at a later date. Both of these CRIDs are associated with the audio and video components in the MPEG transport stream that is broadcast by a local antenna, which wirelessly transmits the audio/video stream for receipt by suitable television receiving apparatus. Each CRID has substantially the same start and end time as the audio and video content with which it is associated.

In the case where multiple CRIDs are multiplexed into the audio/video stream, the content reference identifiers may have different start and end times. This is illustrated in FIG. 3. Embedded in the stream 40 are three different CRIDs A, B and C, each of which has different start and end times. Their existence over time is shown by the extent of the arrow in the Figure. CRIDs A and B could be, for example, a sports programme and a “magazine” style programme respectively. These two CRIDS overlap for the period in which there is a commercial break between the programmes. CRID C may be, for example, for a film that is to be broadcast later by the network, but is previewed during the “magazine” style programme. The CRID C is associated with the audio/video stream for the period of time during the “magazine” programme that the film is being previewed.

A suitable receiving apparatus for the audio/video stream is the receiving apparatus 22, shown in FIG. 2. This would typically be a digital television receiver and comprises receiving means 32 in the form of a standard television aerial for receiving the audio/video stream that comprises the video component, the audio component and at least one embedded CRID. The apparatus 22 further comprises a demultiplexer 34 for demultiplexing the audio/video stream and an audio/video decoder 36 for supplying the video component of the stream to a display device (not shown) and for supplying the audio component to an audio device (not shown). Included within the receiver 22 is a CRID decoder 38 for receiving the CRID(s) from the demultiplexer 34.

The receiver 22 stores the decoded CRIDs locally and can recall them and process them as desired. Typically this occurs in response to some user request relating to the content that they are viewing. For example, the user can select, via a remote control, information on the content that is associated with the embedded CRID. Therefore, taking the example described with respect to FIG. 3, a user, while watching the “magazine” programme, may be interested in seeing the film previewed during the “magazine” programme. The user accesses the interactive features of the receiver 22 via the remote control and can inform the receiver 22 that they wish to record the previewed film when it is broadcast. The receiver 22 recalls the stored CRID and actions the user request, according to the predefined methodology of the TV Anytime standard.

To take advantage of these embedded CRIDs, a number of desired features need to be enabled. This invention proposes methods for embedding a CRID in an A/V stream in such a way that these features are enabled. In particular, it specifies a number of means by which a TV Anytime CRID can be embedded in an MPEG-2 transport stream. Typically the TV Anytime CRID will be embedded repeatedly in the MPEG-2 transport stream, as shown in FIG. 4. The following techniques for inserting the CRID and associated data are proposed. The nature of what data needs to be coded and how it is encoded is the same for all techniques and is discussed below.

1. Define a new descriptor (containing a list of CRIDs and associated data) in the first outer descriptor loop of the Program Map Table (PMT)—see page 50 of ISO/IEC JTC 1/SC 29 (MPEG-2 Systems) for details of the PMT.

2. Define a new table format to contain the list of CRIDs and associated data. The table will be carried on a PID identified in the second descriptor loop of the PMT. A pre-defined stream_type field value would be used to allow receivers to identify that this stream contains TV Anytime CRID information.

3. Use of private_sections( ) in the transport stream packets which have the same PID as the PMT—see 2.4.4.10 of the MPEG-2 Systems specification (p. 52). This is a similar solution to the previous one with the advantage that the overhead of an extra PID is avoided and the link between the service and the CRID information is implicit.

4. Insert the CRID list and associated data in a new descriptor inside the inner descriptor loop of EIT present/following table.

5. Define a format for carrying the CRID list and associated data in private format Transport Stream packets. The PID of these packets would be identified in the same was as solution 2

6. Insert the CRID list and associated data in private_data_bytes carried inside a Transport Stream adaption field (see page 24 of MPEG-2 Systems).

7. Insert the CRID list and associated data inside the padding bits of transport stream packets.

8. Insert the CRID list and associated data inside MPEG-2 Video user_data or extension_data sections (see page 29 of ISOJEC 13818-2). The data would be stored in the video elementary stream, and so would be more tightly linked to it.

9. Insert the CRID list and associated data inside a video descriptor DSMCC stream event.

A running status flag is associated with each embedded CRID. The following statuses are defined: “not running”, “starts in a few seconds”, “pausing”, and “running”. All these solutions are based around carouselling the data. Some CRIDs require higher repeat rates (i.e. the time frame within which the PDR must become aware of a change to the status of a CRID must be smaller) than others, which leads to the following enhancements:
Solutions involving the use of MPEG-2 tables (numbers 2 and 4) should allow some of the CRIDs to be carouselled with a higher repeat rate. This allows faster response times for indicating the start of a recording, say, than compared to finding out that a programme has a parent series (which is not so time critical).
If the bandwidth required to carousell the data for multiple CRIDs at a high rate is undesirably high, then a solution should be adopted whereby a key is assigned to each CRID and associated data using a low repeat rate table (approx. 20 second repeat time). Another table is then used which maps the key to a running status flag and this can be repeated at a much higher rate (approx. 1 second repeat time). This scenario is illustrated in FIG. 5.
A separate table could be defined which is only sent out when the status of a CRID changes and is not otherwise repeated. The intention being that this could be used for events that need to be indicated with a high degree of time accuracy, such as indicating the exact start of a programme to facilitate accurate recording.

FIG. 3 illustrates the use of multiple simultaneous TV Anytime CRIDs within an A/V stream. Inserting multiple TV Anytime CRIDs in an A/V stream enables the following features:
Time accurate recording of TV Anytime identified content, regardless of the broadcast system being used
The ability to distinguish between different parts of hierarchical programmes (i.e. omnibus and magazine programmes)
The ability to record a programme using one button press when watching a trailer
The ability to record programmes related to the current A/V content in some way (e.g. next episode, a whole series, advert for merchandise featured in programme, etc.)

The invention is applicable to any TV Anytime compliant device concerned with handling A/V streams, The invention covers both head-end A/V stream transmitter systems as well as devices capable of receiving such streams. The former includes broadcast delivery head-end systems as well as network servers capable of delivering A/V content with TV Anytime information. The receivers are most likely to be Integrated Digital TVs or set top boxes with storage capability (i.e. Personal Video Recorders), but also any other device capable of receiving and displaying A/V streams (PCs, PDAs, etc.). The audio/video stream can be recorded on, for example, optical storage devices such as DVD+RW, which recording will include the embedded TV Anytime content reference identifier.

The DVD Video format uses an MPEG-2 program stream format. Whenever compatibility with existing DVD Video devices is required, it is necessary to remultiplex the broadcast (transport stream) format and its associated data, such as the CRID information, into a DVD Videocompatible program stream. If one of the means of embedding the CRID information that is specific to a Transport Stream, described in 1-7 or 9 of section 3, is used; and it is necessary to embed the CRID information into a suitable program stream structure, candidates are to embed it into a private PES packet, or the private data of a PES header. For DVD Video compatibility, a private PES packet (using the “provider defined” sub stream ID) would be the preferred method.

In this way, if the DVD is then transferred to another device, then the content reference identifier will be available to the user when the content is played back. The user will then have access to all the enhancements delivered by TV Anytime, via the device's recognition of the content reference identifier.

1. A method of creating an audio/video stream comprising multiplexing a video component, an audio component and a content reference identifier, said content reference identifier being associated with said video component and said audio component in an MPEG transport stream.

2. A method according to claim 1, wherein said multiplexing includes simultaneously multiplexing multiple content reference identifiers into said audio/video stream.

3. A method according to claim 2, wherein said multiple content reference identifiers have different start and end times.

4. A method according to claim 1, 2 or 3, wherein a content reference identifier has substantially the same start and end times as the video and audio components with which it is associated.

5. Apparatus for transmitting an audio/video stream comprising a multiplexer for multiplexing a video component, an audio component and a content reference identifier, said content reference identifier being associated with said video component and said audio component in an MPEG transport stream, and transmitting means for transmitting the resulting audio/video stream.

6. Apparatus according to claim 5, and further comprising an audio/video encoder for supplying said video component and said audio component to said multiplexer.

7. Apparatus according to claim 5 or 6, wherein said multiplexer simultaneously multiplexes multiple content reference identifiers into audio/video stream.

8. Apparatus for receiving an audio/video stream comprising receiving means for receiving an audio/video stream comprising a video component, an audio component and a content reference identifier, said content reference identifier being associated with said video component and said audio component in an MPEG transport stream and a demultiplexer for demultiplexing said audio/video stream.

9. Apparatus according to claim 8, and further comprising an audio/video decoder for supplying said video component to a display device and for supplying said audio component to an audio device.

10. An audio/video stream comprising a video component, an audio component and a content reference identifier, said content reference identifier being associated with said video component and said audio component in an MPEG transport stream.
